(19) United States
(12) Patent Application Publication
(10) Pub. No.: US 2017/0176992 A1
(43) Pub. Date: Jun. 22, 2017

(54) METHOD AND DEVICE FOR RETRIEVING AND FLYING UNMANNED AERIAL VEHICLE IN HANDHELD MANNER

(71) Applicant: BEIJING ZERO ZERO INFINITY TECHNOLOGY CO., LTD, Beijing (CN)

(72) Inventors: Mengqiu WANG, Beijing (CN); Tong ZHANG, Beijing (CN); Qicheng LI, Beijing (CN); Jia LU, Beijing (CN); Lixin LIU, Beijing (CN)

(73) Assignee: BEIJING ZERO ZERO INFINITY TECHNOLOGY CO., LTD, Beijing (CN)

(21) Appl. No.: 15/115,760

(22) PCT Filed: Jan. 11, 2016
(86) PCT No.: PCT/CN2016/070579

§ 371 Date: Aug. 1, 2016

(30) Foreign Application Priority Data
Aug. 10, 2015 (CN) 201510487415.0

(51) Int. Cl. G05D 1/00; G05D 1/10; B64C 39/02

(52) U.S. Cl. CPC G05D 1/0088; B64C 39/024; G05D 1/101; B64C 2201/08; B64C 2201/024

(57) ABSTRACT

A method and a device for flying an unmanned aerial vehicle in a handheld manner and an unmanned aerial vehicle are provided. The method includes: judging whether the unmanned aerial vehicle is triggered to enter a flight standby state; determining whether the unmanned aerial vehicle is in a handheld flat-laying state for a predetermined time period when it enters the flight standby state; and comparing a state parameter of the unmanned aerial vehicle with the state parameter thereof at a previous time instant to judge whether it is released when it is in the handheld flat-laying state, and controlling its rotor wing to rotate for flight when the unmanned aerial vehicle is released. The method is easy to implement, the elimination of the remote control results in a cost saving and the user does not need to operate the remote control.

### CROSS REFERENCE OF RELATED APPLICATION

This application claims the priority to Chinese Patent Application No. 201510487415.0, titled “METHOD AND DEVICE FOR FLYING UNMANNED AERIAL VEHICLE IN HANDHELD MANNER AND UNMANNED AERIAL VEHICLE”, filed on Aug. 10, 2015 with State Intellectual Property Office of PRC, which is hereby incorporated by reference in its entirety.

### FIELD

The disclosure relates to the technical field of unmanned aerial vehicle control technologies, and in particular to a method and a device for flying an unmanned aerial vehicle in a handheld manner and an unmanned aerial vehicle.

### BACKGROUND

At present, an unmanned aerial vehicle is becoming widely used. For example, the unmanned aerial vehicle may be employed for aerial photography during sport events and conferences.

In the conventional art, the unmanned aerial vehicle is flied in the following manner.

A switch of the unmanned aerial vehicle is turned on and the unmanned aerial vehicle is placed on the ground or other surfaces, then a rotor wing of the unmanned aerial vehicle is controlled to rotate with a remote control or a similar remote control device such as a cell phone to fly the unmanned aerial vehicle.

However, flying the unmanned aerial vehicle with the remote control requires remote control skill and steering capability of an operator.

Therefore, there is a need for a method for flying the unmanned aerial vehicle without the user operating the remote control to control the unmanned aerial vehicle.

### SUMMARY

To solve the above technical issue, a method and a device for flying an unmanned aerial vehicle in a handheld manner and an unmanned aerial vehicle are provided to fly the unmanned aerial vehicle in a handheld manner without using a remote control.

It is provided a method for flying an unmanned aerial vehicle in a handheld manner according to the embodiment of the disclosure, which includes:

judging whether the unmanned aerial vehicle is triggered to enter a flight standby state;

determining whether the unmanned aerial vehicle is in a handheld flat-laying state for a predetermined time period in a case of determining that the unmanned aerial vehicle enters the flight standby state; and

comparing a state parameter of the unmanned aerial vehicle with the state parameter thereof at a previous time instant to judge whether the unmanned aerial vehicle is released in a case of determining that the unmanned aerial vehicle is in the handheld flat-laying state, and controlling a rotor wing of the unmanned aerial vehicle to rotate for flight in a case of determining that the unmanned aerial vehicle is released.

Preferably, the judging whether the unmanned aerial vehicle is triggered to enter the flight standby state may include:

judging whether a flight standby switch provided on the unmanned aerial vehicle is turned on; or

judging whether a motion trajectory along which the unmanned aerial vehicle is lifted by hand follows a predetermined flight standby trajectory.

Preferably, the judging whether a motion trajectory along which the unmanned aerial vehicle is lifted by hand follows the predetermined flight standby trajectory, to judge whether the unmanned aerial vehicle is triggered to enter the flight standby state, may include:

detecting a position parameter (xᵢ, yᵢ, zᵢ) of the unmanned aerial vehicle at a time instant tᵢ, where xᵢ and yᵢ are two-dimensional coordinates on a x-axis and a y-axis in a horizontal plane parallel to the ground respectively, zᵢ is a coordinate on a z-axis perpendicular to the ground, and tᵢ is a timestamp;

judging whether components of the motion trajectory of the unmanned aerial vehicle in the x-axis and the y-axis extend monotonically in a positive direction or a negative direction along the x-axis and the y-axis respectively according to xᵢ and yᵢ, and judging whether a component of the motion trajectory of the unmanned aerial vehicle in the z-axis extends monotonically in a positive direction along the z-axis according to zᵢ;

determining that the unmanned aerial vehicle enters the flight standby state in a case of determining that the components of the motion trajectory of the unmanned aerial vehicle in the x-axis and the y-axis extend monotonically in the positive direction or the negative direction along the x-axis and the y-axis respectively, and the component of the motion trajectory of the unmanned aerial vehicle in the z-axis extends monotonically in the positive direction along the z-axis.

Preferably, whether the component of the motion trajectory of the unmanned aerial vehicle in the x-axis extends monotonically in the positive direction or the negative direction along the x-axis is judged according to xᵢ with the following equation:

$$\vert \sum \frac{{dx}_{i}}{{dt}_{i}} \vert \geq {T}_{1} \sum \vert \frac{{dx}_{i}}{{dt}_{i}} \vert ;$$

whether the component of the motion trajectory of the unmanned aerial vehicle in the y-axis extends monotonically in the positive direction or the negative direction along the y-axis is judged according to yᵢ with the following equation:

$$\vert \sum \frac{{dy}_{i}}{{dt}_{i}} \vert \geq {T}_{1} \sum \vert \frac{{dy}_{i}}{{dt}_{i}} \vert ;$$

whether the component of the motion trajectory of the unmanned aerial vehicle in the z-axis extends monotonically in the positive direction along the z-axis is judged according to zᵢ with the following equation:

$$\sum \frac{{dz}_{i}}{{dt}_{i}} \geq {T}_{2} \sum \vert \frac{{dz}_{i}}{{dt}_{i}} \vert ,$$

where T₁ is a preset value greater than 0 and less than or equal to 1, and T₂ is a preset value greater than 0 and less than or equal to 1.

Preferably, the determining whether the unmanned aerial vehicle is in a handheld flat-laying state for a predetermined time period may include:

acquiring an amount of position change of the unmanned aerial vehicle based on the position parameter of the unmanned aerial vehicle;

acquiring an amount of attitude change of the unmanned aerial vehicle based on an attitude parameter of the unmanned aerial vehicle; and

determining that the unmanned aerial vehicle is in the handheld flat-laying state for a case that the amount of position change of the unmanned aerial vehicle is less than a preset position change amount threshold and the amount of attitude change of the unmanned aerial vehicle is less than a preset attitude change amount threshold.

Preferably, the amount of position change of the unmanned aerial vehicle Vₜ_{ᵢ}^{P} may be acquired based on the position parameter of the unmanned aerial vehicle with the following equation:

Vₜ_{ᵢ}^{P}=|dxᵢ|+|dyᵢ|+|dzᵢ|,

where (xᵢ, yᵢ, zᵢ) is the position parameter of the unmanned aerial vehicle at a time instant tᵢ, xᵢ and yᵢ are two-dimensional coordinates on the x-axis and the y-axis in a horizontal plane parallel to the ground respectively, zᵢ is a coordinate on the z-axis perpendicular to the ground, and tᵢ is a timestamp; and

the amount of attitude change of the unmanned aerial vehicle Vₜ_{ᵢ}^{O} may be acquired based on the attitude parameter of the unmanned aerial vehicle with the following equation:

Vₜ_{ᵢ}^{O}=|dφᵢ|+|dθᵢ|+|dψᵢ|,

where (φᵢ,θᵢ,ψᵢ) is the attitude parameter of the unmanned aerial vehicle at the time instant tᵢ, and

the determining that the unmanned aerial vehicle is in the handheld flat-laying state in a case that the amount of position change of the unmanned aerial vehicle is less than the preset position change amount threshold and the amount of attitude change of the unmanned aerial vehicle is less than the preset attitude change amount threshold may include:

determining that the unmanned aerial vehicle is in the handheld flat-laying state in a case that a maximum value of the amount of position change is less than the preset position change amount threshold and a maximum value of the amount of attitude change is less than the preset attitude change amount threshold in a predetermined time window (tₐ, t_{b}).

It is provided a device for flying an unmanned aerial vehicle in a handheld manner according to the embodiments of the disclosure, which includes:

a first judgment unit configured to judge whether the unmanned aerial vehicle is triggered to enter a flight standby state;

a second judgment unit configured to judge whether the unmanned aerial vehicle is in a handheld flat-laying state for a predetermined time period in a case of the first judgment unit determining that the unmanned aerial vehicle enters the flight standby state; and

a comparison unit configured to compare a state parameter of the unmanned aerial vehicle with the state parameter thereof at a previous time instant in a case of the second judgment unit determining that the unmanned aerial vehicle is in the handheld flat-laying state; and

a control unit configured to control a rotor wing of the unmanned aerial vehicle to rotate for flight in a case of the comparison unit determining that the unmanned aerial vehicle is released according to a comparison result.

Preferably, in a case that the first judgment unit is configured to judge whether the unmanned aerial vehicle is triggered to enter a flight standby state by judging whether a motion trajectory along which the unmanned aerial vehicle is lifted by hand follows a predetermined flight standby trajectory, the first judgment unit may include:

a position parameter detection sub-unit configured to detect a position parameter (xᵢ, yᵢ, zᵢ) of the unmanned aerial vehicle at a time instant tᵢ, where xᵢ and yᵢ are two-dimensional coordinates on a x-axis and a y-axis in a horizontal plane parallel to the ground respectively, zᵢ is a coordinate on a z-axis perpendicular to the ground, and tᵢ is a timestamp;

a first judgment sub-unit configured to judge whether components of the motion trajectory of the unmanned aerial vehicle in the x-axis and the y-axis extend monotonically in a positive direction or a negative direction along the x-axis and the y-axis respectively according to xᵢ and yᵢ, and judge whether a component of the motion trajectory of the unmanned aerial vehicle in the z-axis extends monotonically in a positive direction along the z-axis according to zᵢ;

a first determination sub-unit configured to determine that the unmanned aerial vehicle enters the flight standby state, in a case of the first judgment sub-unit judging that the components of the motion trajectory of the unmanned aerial vehicle in the x-axis and the y-axis extend monotonically in the positive direction or the negative direction along the x-axis and the y-axis respectively, and the component of the motion trajectory of the unmanned aerial vehicle in the z-axis extends monotonically in the positive direction along the z-axis.

Preferably, the second judgment unit may include:

a position change amount acquisition sub-unit configured to acquire an amount of position change of the unmanned aerial vehicle based on the position parameter of the unmanned aerial vehicle;

an attitude change amount acquisition sub-unit configured to acquire an amount of attitude change of the unmanned aerial vehicle based on an attitude parameter of the unmanned aerial vehicle; and

a second judgment sub-unit configured to determine that the unmanned aerial vehicle is in the handheld flat-laying state in a case that the amount of position change of the unmanned aerial vehicle is less than a preset position change amount threshold and the amount of attitude change of the unmanned aerial vehicle is less than a preset attitude change amount threshold.

It is provided an unmanned aerial vehicle capable of being flown in a handheld manner according to the embodiments of the disclosure, which includes:

a control device configured to judge whether the unmanned aerial vehicle is triggered to enter a flight standby state, determine whether the unmanned aerial vehicle is in a handheld flat-laying state for a predetermined time period in a case of determining that the unmanned aerial vehicle enters the flight standby state; and compare a state parameter of the unmanned aerial vehicle with the state parameter thereof at a previous time instant to judge whether the unmanned aerial vehicle is released in a case of determining that the unmanned aerial vehicle is in the handheld flat-laying state, and transmit a control instruction to a flight control system in a case of determining that the unmanned aerial vehicle is released; and

the flight control system configured to control a rotor wing of the unmanned aerial vehicle to rotate for flight.

The present disclosure has the following advantages as compared with prior art.

With the method for flying an unmanned aerial vehicle in a handheld manner according to the embodiments of the disclosure, a user flies the unmanned aerial vehicle with his/her hand without using a remote control device. That is, the unmanned aerial vehicle judges whether it is flown by a hand, and controls the rotor wing to rotate in a case of determining that it is flown by a hand thus the unmanned aerial vehicle may be flown in a handheld manner. In the method provided according to the embodiments of the disclosure, a step of the user operating the remote control to fly the unmanned aerial vehicle is omitted, and the user does not need to operate the remote control. The unmanned aerial vehicle may judge whether it undergoes a flight standby state, a handheld flat-laying state and a release state successively according to state parameters of the unmanned aerial vehicle, and controls the rotor wing to rotate for flight in a case of determining that it undergoes the flight standby state, the handheld flat-laying state and the release state successively. The method is easy to implement, the elimination of the remote control results in a cost saving and the user does not need to operate the remote control. The unmanned aerial vehicle is free from control by other devices and may judge whether it is flown by a hand according to parameters acquired from the unmanned aerial vehicle.

### BRIEF DESCRIPTION OF THE DRAWINGS

In order to illustrate the technical solutions according to the embodiments of the present disclosure or in the conventional art more clearly, drawings to be used in the description of the embodiments or the conventional art will be described briefly hereinafter. Apparently, the drawings described hereinafter are only some embodiments of the present disclosure, and other drawings may be obtained by those skilled in the art according to these drawings without creative labor.

FIG. 1 is a flow chart of a method for flying an unmanned aerial vehicle in a handheld manner according to a first method embodiment of the disclosure;

FIG. 2 is a flow chart of a method for flying an unmanned aerial vehicle in a handheld manner according to a second method embodiment of the disclosure;

FIG. 3 is a schematic diagram of a device for flying an unmanned aerial vehicle in a handheld manner according to a first device embodiment of the disclosure;

FIG. 4 is a schematic diagram of a device for flying an unmanned aerial vehicle in a handheld manner according to a second device embodiment of the disclosure; and

FIG. 5 is a schematic diagram of an unmanned aerial vehicle capable of being flown in a handheld manner according to the disclosure.

### DETAILED DESCRIPTION OF THE EMBODIMENTS

The technical solutions in the embodiments of the present disclosure will be described clearly and completely hereinafter in conjunction with the drawings in the embodiments of the present disclosure. Apparently, the described embodiments are only some but not all of the embodiments of the present disclosure. All the other embodiments obtained by those ordinary skilled in the art based on the embodiments of the present disclosure without creative effort fall within the scope of protection of the present disclosure.

To make the above object, features and advantages of the disclosure more obvious and easy to be understood, in the following, particular embodiments of the disclosure will be explained in detail in conjunction with the drawings.

### A First Method Embodiment

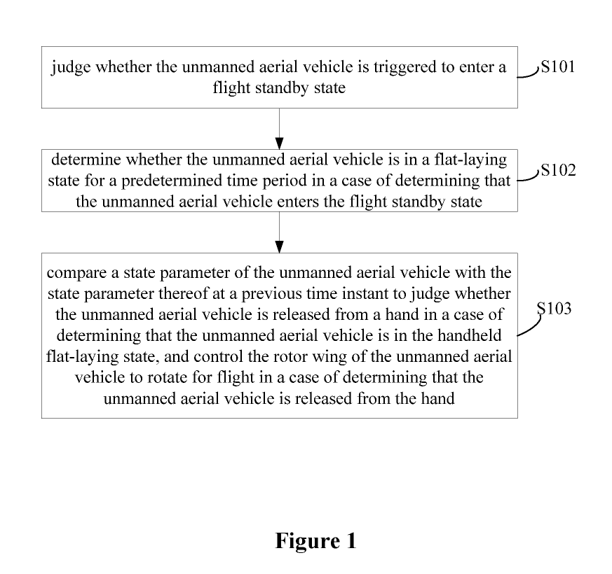

Reference is made to FIG. 1 which is a flow chart of a method for flying an unmanned aerial vehicle in a handheld manner according to a first method embodiment of the disclosure.

The method for flying an unmanned aerial vehicle in a handheld manner according to the embodiment which is applicable to an unmanned aerial vehicle includes the following steps S101 to S103.

In step S101, it is determined whether the unmanned aerial vehicle is triggered to enter a flight standby state.

Particularly, whether the unmanned aerial vehicle is triggered to enter the flight standby state may be judged using either of the following two methods.

In a first method, it is judged whether a flight standby switch provided on the unmanned aerial vehicle is turned on.

In a second method, it is judged whether a motion trajectory along which the unmanned aerial vehicle is lifted by hand follows a predetermined flight standby trajectory.

For example, the predetermined flight standby trajectory may be a trajectory along which the unmanned aerial vehicle travels when the unmanned aerial vehicle is lifted by hand. Specifically, when a user needs to fly the unmanned aerial vehicle, it is judged that the unmanned aerial vehicle is triggered to enter the flight standby state in a case that the motion trajectory along which the unmanned aerial vehicle is lifted by hand follows the predetermined flight standby trajectory.

In step S102, it is judged whether the unmanned aerial vehicle is in a handheld flat-laying state for a predetermined time period in a case of determining that the unmanned aerial vehicle enters the flight standby state.

It should be noted that, after entering the flight standby state, the unmanned aerial vehicle is in the handheld flat-laying state. That is, the user holds the unmanned aerial vehicle stably and then releases the hand to fly the unmanned aerial vehicle.

In step S103, a state parameter of the unmanned aerial vehicle is compared with the state parameter thereof at a previous time instant to judge whether the unmanned aerial vehicle is released from the hand in a case of determining that the unmanned aerial vehicle is in a handheld flat-laying state, and a rotor wing of the unmanned aerial vehicle is controlled to rotate for flight in a case of judging that the unmanned aerial vehicle is released from the hand.

A self-adaptation process of the unmanned aerial vehicle is completed for flight when it is determined that the unmanned aerial vehicle is released from the hand. It should be noted that flying the unmanned aerial vehicle in a handheld manner according to the disclosure indicates that the unmanned aerial vehicle may maintain a hovering state in the air after the unmanned aerial vehicle is released from the hand. It will be appreciated that a velocity and an angular velocity of the unmanned aerial vehicle are zero when the unmanned aerial vehicle is in the hovering state.

It should be understood that, with the method for flying an unmanned aerial vehicle in a handheld manner according to the disclosure, the unmanned aerial vehicle may be flown directly by hand without any remote device. Therefore, a state parameter of the unmanned aerial vehicle is detected by a sensor such as an accelerometer or a gyroscope provided on the unmanned aerial vehicle.

With the method for flying an unmanned aerial vehicle in a handheld manner according to the embodiment, a user flies the unmanned aerial vehicle with his/her hand without using a remote control device. That is, the unmanned aerial vehicle judges whether it is flown by a hand, and controls the rotor wing to rotate in a case that it is flown by a hand thus the unmanned aerial vehicle may be flown in a handheld manner. In the method provided according to the embodiment of the disclosure, a step of the user operating the remote control to fly the unmanned aerial vehicle is omitted, and the user does not need to operate the remote control. The unmanned aerial vehicle may judge whether it undergoes a flight standby state, a handheld flat-laying state and a release state successively according to state parameters of the unmanned aerial vehicle, and controls the rotor wing to rotate for flight in a case of judging that it undergoes the flight standby state, the handheld flat-laying state and the release state successively. The method is easy to implement, the elimination of the remote control results in a cost saving and the user does not need to operate the remote control. The unmanned aerial vehicle is free from control by other devices and may determine whether it is flown by a hand according to parameters acquired from the unmanned aerial vehicle.

In addition, it should be noted that a method for retrieving an unmanned aerial vehicle in a handheld manner according to the disclosure is applicable to an unmanned aerial vehicle where the rotor wing of the unmanned aerial vehicle is disposed within a housing, i.e., the housing is disposed outside the rotor wing thus the rotating rotor wing does not injure the hand of the user when the unmanned aerial vehicle is retrieved in a handheld manner.

### A Second Method Embodiment

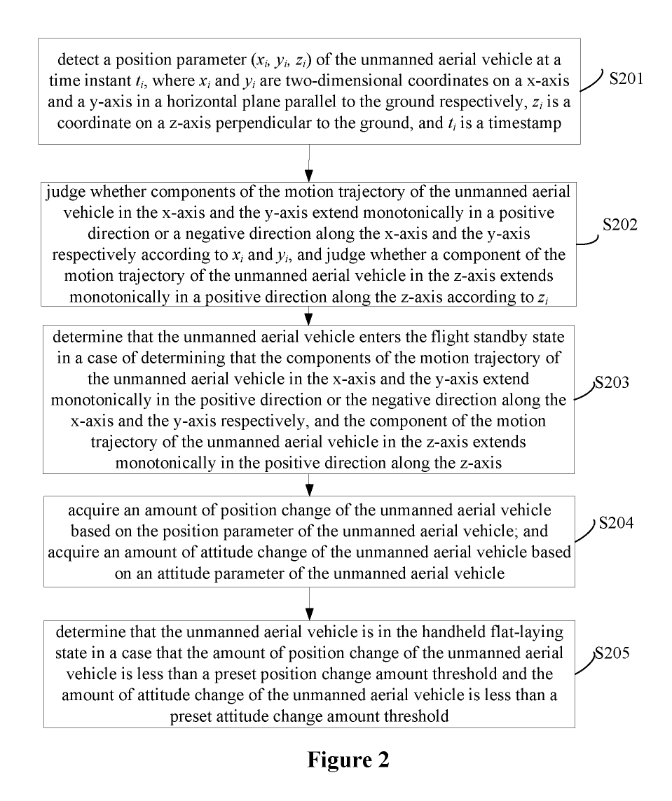

Reference is made to FIG. 2 which is a flow chart of a method for flying an unmanned aerial vehicle in a handheld manner according to a second method embodiment of the disclosure.

In this embodiment, a specific implementation where a judgment whether an unmanned aerial vehicle is triggered to enter a flight standby state is made by judging whether a motion trajectory along which the unmanned aerial vehicle is lifted by hand follows a predetermined flight standby trajectory is described.

In a case that the judgment whether an unmanned aerial vehicle is triggered to enter a flight standby state is made by judging whether a motion trajectory along which the unmanned aerial vehicle is lifted by hand follows a predetermined flight standby trajectory, the method includes the following steps S201 to S206.

In step S201, a position parameter (xᵢ, yᵢ, zᵢ) of the unmanned aerial vehicle at a time instant tᵢ is detected, where xᵢ and yᵢ are two-dimensional coordinates on a x-axis and a y-axis in a horizontal plane parallel to the ground respectively, zᵢ is a coordinate on a z-axis perpendicular to the ground, and tᵢ is a timestamp.

In step S202, it is judged whether components of the motion trajectory of the unmanned aerial vehicle in the x-axis and the y-axis extend monotonically in a positive direction or a negative direction along the x-axis and the y-axis respectively according to xᵢ and yᵢ, and it is judged whether a component of the motion trajectory of the unmanned aerial vehicle in the z-axis extends monotonically in a positive direction along the z-axis according to zᵢ.

In step S203, it is determined that the unmanned aerial vehicle enters the flight standby state in a case of determining that the components of the motion trajectory of the unmanned aerial vehicle in the x-axis and the y-axis extend monotonically in the positive direction or the negative direction along the x-axis and the y-axis respectively, and the component of the motion trajectory of the unmanned aerial vehicle in the z-axis extends monotonically in the positive direction along the z-axis.

Assuming that the motion trajectory along which the unmanned aerial vehicle is lifted by hand is a parabola in a three-dimensional space, a relationship between the corresponding position parameter and time may be represented by the following equation (1):

$$\{ \begin{matrix}{x}_{i} = {a}_{1} {t}_{i} + {β}_{1} \\ {y}_{i} = {a}_{2} {t}_{i} + {β}_{2} \\ {z}_{i} = {a}_{3} ( {x}_{i}^{2} + {y}_{i}^{2} )\end{matrix} , \qquad ( 1 )$$

where a₃>0, α₁, α₂, β₁ and β₂ are preset coefficients.

An expression of the velocity of the unmanned aerial vehicle in the x-axis, y-axis and z-axis may be acquired according to equation (1), as represented by the following equation (2):

$$\{ \begin{matrix}\frac{{dx}_{i}}{{dt}_{i}} = {a}_{1} \\ \frac{{dy}_{i}}{{dt}_{i}} = {a}_{2} \\ \frac{{d}^{2} {z}_{i}}{{dt}_{i}^{2}} = 2 {a}_{3} ( {a}_{1}^{2} + {a}_{2}^{2} ) > 0\end{matrix} . \qquad ( 2 )$$

As can be seen from equation (2), during a process of lifting the unmanned aerial vehicle, horizontal components of the movement of the unmanned aerial vehicle, i.e., horizontal components in the x-axis and the y-axis are monotonic, and a vertical component of the movement of the unmanned aerial vehicle is monotonic in the positive direction of the z-axis. That is, the unmanned aerial vehicle performs an ascending motion along the z-axis.

However, during the process of lifting the unmanned aerial vehicle, movement of the unmanned aerial vehicle cannot follow strictly the above equation since the unmanned aerial vehicle may vibrate or fluctuate for a short period of time, the judgment condition may be relaxed to take the vibration into consideration in the disclosure. It should be understood that

$$\vert \sum \frac{{dx}_{i}}{{dt}_{i}} \vert = \sum \vert \frac{{dx}_{i}}{{dt}_{i}} \vert$$

in a case that the movement of the unmanned aerial vehicle in the x-axis directs continuously toward the positive direction or negative direction of the x-axis, and

$$\vert \sum \frac{{dx}_{i}}{{dt}_{i}} \vert < \sum \vert \frac{{dx}_{i}}{{dt}_{i}} \vert$$

in a case that the movement of the unmanned aerial vehicle fluctuates in a direction of the x-axis. Therefore, a relaxed threshold T₁ is set to avoid the fluctuation from affecting the judgment. Similarly, a relaxed threshold T₁ is set for the y-axis, and a relaxed threshold T₂ is set for the z-axis. That is, the judgment may be made with the following equations (4), (5) and (6).

It is judged whether the component of the motion trajectory of the unmanned aerial vehicle in the x-axis extends monotonically in the positive direction or the negative direction along the x-axis according to xᵢ with the following equation:

$$\vert \sum \frac{{dx}_{i}}{{dt}_{i}} \vert \geq {T}_{1} \sum \vert \frac{{dx}_{i}}{{dt}_{i}} \vert ; \qquad ( 4 )$$

it is judged whether the component of the motion trajectory of the unmanned aerial vehicle in the y-axis extends monotonically in the positive direction or the negative direction along the y-axis according to yᵢ with the following equation:

$$\vert \sum \frac{{dy}_{i}}{{dt}_{i}} \vert \geq {T}_{1} \sum \vert \frac{{dy}_{i}}{{dt}_{i}} \vert ; \qquad ( 5 )$$

and it is judged whether the component of the motion trajectory of the unmanned aerial vehicle in the z-axis extends monotonically in the positive direction along the z-axis according to zᵢ with the following equation:

$$\sum \frac{{dz}_{i}}{{dt}_{i}} \geq {T}_{2} \sum \vert \frac{{dz}_{i}}{{dt}_{i}} \vert , \qquad ( 6 )$$

where T₁ is a preset value greater than 0 and less than or equal to 1, and T₂ is a preset value greater than 0 and less than or equal to 1.

It may be determined that the unmanned aerial vehicle is triggered to enter the flight standby state in a case that components of the movement of the unmanned aerial vehicle in the x-axis, y-axis and z-axis satisfy the equations (4), (5) and (6).

In step S204, an amount of position change of the unmanned aerial vehicle is acquired based on the position parameter of the unmanned aerial vehicle; and an amount of attitude change of the unmanned aerial vehicle is acquired based on an attitude parameter of the unmanned aerial vehicle.

In step S205, it is determined that the unmanned aerial vehicle is in the handheld flat-laying state in a case that the amount of position change of the unmanned aerial vehicle is less than a preset position change amount threshold and the amount of attitude change of the unmanned aerial vehicle is less than a preset attitude change amount threshold.

It should be understood that, in the present disclosure, the unmanned aerial vehicle judges whether it is in a handheld flat-laying state according to a resistance received by the unmanned aerial vehicle from the hand. It may be judged whether the unmanned aerial vehicle is in a handheld flat-laying state with the following method.

The state parameter of the unmanned aerial vehicle may be expressed as (tᵢ, xᵢ, yᵢ, zᵢ, φᵢ, θᵢ, ψᵢ), where (xᵢ, yᵢ, zᵢ) is the position parameter of the unmanned aerial vehicle at a time instant tᵢ, xᵢ and yᵢ are coordinates on the x-axis and the y-axis in a horizontal plane parallel to the ground respectively, zᵢ is a coordinate on the z-axis perpendicular to the ground, and tᵢ is a timestamp; (φᵢ, θᵢ, ψᵢ) is the attitude parameter of the unmanned aerial vehicle at the time instant tᵢ, φᵢ, θᵢ, ψᵢ indicate angles between the unmanned aerial vehicle and the x-axis, y-axis and z-axis respectively.

The amount of position change of the unmanned aerial vehicle Vₜ_{ᵢ}^{P} is acquired based on the position parameter of the unmanned aerial vehicle with the following equation:

Vₜ_{ᵢ}^{P}=|dxᵢ|+|dyᵢ|+|dzᵢ|.

The amount of attitude change of the unmanned aerial vehicle Vₜ_{ᵢ}^{O} is acquired based on the attitude parameter of the unmanned aerial vehicle with the following equation:

Vₜ_{ᵢ}^{O}=|dφᵢ|+|dθᵢ|+|dψᵢ|.

It is determined that the unmanned aerial vehicle is disturbed by the hand in a case that the amount of position change of the unmanned aerial vehicle is less than the preset position change amount threshold and the amount of attitude change of the unmanned aerial vehicle is less than the preset attitude change amount threshold.

Further, it may be represented by the following equation, where t indicates a time instant at which the rotor wing stops rotating. In a case that the following equation is satisfied during a time period from tₐ to t_{b} before t, the rotor wing may be controlled to stop rotating at the time instant t:

t={Cₜ_{ᵢ}^{P}<thr_{P}&Cₜ_{ᵢ}^{O}<thr_{O}},

where

$${C}_{{t}_{i}}^{P} = {{max}_{i = a}}^{b} {V}_{{t}_{i}}^{P} , {C}_{{t}_{i}}^{O} = {{max}_{i = a}}^{b} {V}_{{t}_{i}}^{O} ,$$

the time instant t is subsequent to the time instant t_{b}, the rotor wing is controlled to stop rotating at the time instant t.

That is, in a case that a maximum value of the amount of position change Vₜ_{ᵢ}^{P} is less than the preset position change amount threshold thrₚ and a maximum value of the amount of attitude change is less than the preset attitude change amount threshold thr_{O} during the time period from tₐ to t_{b}, the rotor wing may be controlled to stop rotating at the time instant t subsequent to t_{b}.

It should be understood that, the rotor wing being controlled to stop rotating at a time instant subsequent to t_{b} indicates that the rotor wing may be controlled to stop rotating at any time instant subsequent to t_{b}. However, the rotor wing is controlled to stop rotating at a time instant at which the above equation is satisfied for the first time thus the rotor wing may be stopped from rotating as soon as possible.

For example, given a time window for judgment T has a length of T=t_{b}−tₐ, if it is determined that the condition for stopping the rotor wing from rotating is satisfied in a first time window and the condition for stopping the rotor wing from rotating is also satisfied in a second time window, the rotor wing may be stopped from rotating at a time instant subsequent to the first time window, and the judgment does not need to be made in the second time window.

In step S206, a state parameter of the unmanned aerial vehicle is compared with the state parameter thereof at a previous time instant to judge whether the unmanned aerial vehicle is released from the hand in a case of determining that the unmanned aerial vehicle is in a handheld flat-laying state, and the rotor wing of the unmanned aerial vehicle is controlled to rotate for flight in a case of determining that the unmanned aerial vehicle is released from the hand.

When the unmanned aerial vehicle is in the handheld flat-laying state for the predetermined time period, a current position of the unmanned aerial vehicle may be determined to be an initial position. It should be noted that, the velocity and the angular velocity of the unmanned aerial vehicle are zero when the unmanned aerial vehicle is in the handheld flat-laying state. When the unmanned aerial vehicle is released from the hand, the self-adaptation process of the unmanned aerial vehicle needs to be performed thus the unmanned aerial vehicle may stably hover in the air. At the time instant at which the unmanned aerial vehicle is released from the hand, the unmanned aerial vehicle needs to adjust its attitude to be in the initial position. Therefore, various sensors provided on the unmanned aerial vehicle detect a state of the unmanned aerial vehicle, a current state is compared with a state at the initial position, and parameters such as the velocity, the angular velocity and an acceleration of the unmanned aerial vehicle are controlled according to the comparison result, thus the unmanned aerial vehicle is able to stably hover in the air after the unmanned aerial vehicle is released from the hand, i.e., the unmanned aerial vehicle may maintain a same state as at the initial position.

Based on the above method for flying an unmanned aerial vehicle in a handheld manner according to the embodiments of the disclosure, a device for flying an unmanned aerial vehicle in a handheld manner is further provided according to the embodiments of the disclosure, and the operation principle thereof will be described in more detail in conjunction with the drawings in the following.

### A First Device Embodiment

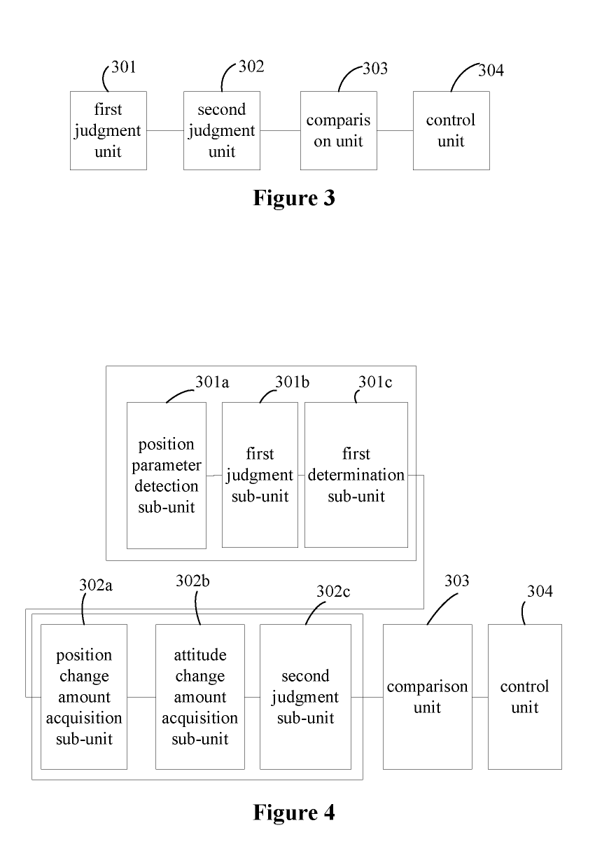

Reference is made to FIG. 3, which is a schematic diagram of a device for flying an unmanned aerial vehicle in a handheld manner according to a first device embodiment of the disclosure.

The device for flying an unmanned aerial vehicle in a handheld manner according to the embodiment includes a first judgment unit 301, a second judgment unit 302, a comparison unit 303 and a control unit 304.

The first judgment unit 301 is configured to judge whether an unmanned aerial vehicle is triggered to enter a flight standby state.

Particularly, whether the unmanned aerial vehicle is triggered to enter the flight standby state may be judged using either of the following two methods.

In a first method, it is judged whether a flight standby switch provided on the unmanned aerial vehicle is turned on.

In a second method, it is judged whether a motion trajectory along which the unmanned aerial vehicle is lifted by hand follows a predetermined flight standby trajectory.

For example, the predetermined flight standby trajectory may be a trajectory along which the unmanned aerial vehicle travels when the unmanned aerial vehicle is lifted by hand. Specifically, when a user needs to fly the unmanned aerial vehicle, it is judged that the unmanned aerial vehicle is triggered to enter the flight standby state in a case that the motion trajectory along which the unmanned aerial vehicle is lifted by hand follows the predetermined flight standby trajectory.

The second judgment unit 302 is configured to judge whether the unmanned aerial vehicle is in a handheld flat-laying state for a predetermined time period in a case that the first judgment unit determines that the unmanned aerial vehicle enters the flight standby state.

It should be noted that, after entering the flight standby state, the unmanned aerial vehicle is in the handheld flat-laying state. That is, the user holds the unmanned aerial vehicle stably and then releases the hand to fly the unmanned aerial vehicle.

The comparison unit 303 is configured to compare a state parameter of the unmanned aerial vehicle with the state parameter thereof at a previous time instant in a case that the second judgment unit determines that the unmanned aerial vehicle is in a handheld flat-laying state.

The control unit 304 is configured to control a rotor wing of the unmanned aerial vehicle to rotate for flight in a case of the comparison unit determining that the unmanned aerial vehicle is released from the hand according to a comparison result.

A self-adaptation process of the unmanned aerial vehicle is completed for flight when it is determined judged that the unmanned aerial vehicle is released from the hand.

It should be understood that, with the method for flying an unmanned aerial vehicle in a handheld manner according to the disclosure, the unmanned aerial vehicle may be flown directly by hand without any remote device. Therefore, a state parameter of the unmanned aerial vehicle is detected by a sensor such as an accelerometer or a gyroscope provided on the unmanned aerial vehicle.

With the device for flying an unmanned aerial vehicle in a handheld manner according to the embodiment, a user flies the unmanned aerial vehicle with his/her hand without using any remote control device. That is, the unmanned aerial vehicle judges whether it is flown by a hand, and controls the rotor wing to rotate in a case that it is flown by a hand thus the unmanned aerial vehicle may be flown in a handheld manner. In the device provided according to the embodiment of the disclosure, a remote control operated by the user for flying the unmanned aerial vehicle is omitted, and the user does not need to operate the remote control. The unmanned aerial vehicle may judge whether it undergoes a flight standby state, a handheld flat-laying state and a release state successively according to state parameters of the unmanned aerial vehicle, and controls the rotor wing to rotate for flight in a case of determining that it undergoes the flight standby state, the handheld flat-laying state and the release state successively. The method is easy to implement, the elimination of the remote control results in a cost saving and the user does not need to operate the remote control. The unmanned aerial vehicle is free from control by other devices and may judge whether it is flown by a hand according to parameters acquired from the unmanned aerial vehicle.

### A Second Device Embodiment

Reference is made to FIG. 4, which is a schematic diagram of a device for flying an unmanned aerial vehicle in a handheld manner according to a second device embodiment of the disclosure.

A device for flying an unmanned aerial vehicle in a handheld manner is provided according to the embodiment, where the first judgment unit 301 is configured to judge whether the unmanned aerial vehicle is triggered to enter a flight standby state by judging whether a motion trajectory along which the unmanned aerial vehicle is lifted by hand follows a predetermined flight standby trajectory, and the first judgment unit 301 includes a position parameter detection sub-unit 301a, a first judgment sub-unit 301b and a first determination sub-unit 301c.

The position parameter detection sub-unit 301a is configured to detect a position parameter (xᵢ, yᵢ, zᵢ) of the unmanned aerial vehicle at a time instant tᵢ, where xᵢ and yᵢ are two-dimensional coordinates on a x-axis and a y-axis in a horizontal plane parallel to the ground respectively, zᵢ is a coordinate on a z-axis perpendicular to the ground, and tᵢ is a timestamp.

The first judgment sub-unit 301b is configured to judge whether components of the motion trajectory of the unmanned aerial vehicle in the x-axis and the y-axis extend monotonically in a positive direction or a negative direction along the x-axis and the y-axis respectively according to xᵢ and yᵢ, and judge whether a component of the motion trajectory of the unmanned aerial vehicle in the z-axis extends monotonically in a positive direction along the z-axis according to zᵢ;

The first determination sub-unit 301c is configured to determine that the unmanned aerial vehicle enters the flight standby state in a case of the first judgment sub-unit 301b judging that the components of the motion trajectory of the unmanned aerial vehicle in the x-axis and the y-axis extend monotonically in the positive direction or the negative direction along the x-axis and the y-axis respectively, and the component of the motion trajectory of the unmanned aerial vehicle in the z-axis extends monotonically in the positive direction along the z-axis.

The second judgment unit 302 includes a position change amount acquisition sub-unit 302a, an attitude change amount acquisition sub-unit 302b and a second judgment sub-unit 302c.

The position change amount acquisition sub-unit 302a is configured to acquire an amount of position change of the unmanned aerial vehicle based on the position parameter of the unmanned aerial vehicle.

The attitude change amount acquisition sub-unit 302b is configured to acquire an amount of attitude change of the unmanned aerial vehicle based on an attitude parameter of the unmanned aerial vehicle.

The second judgment sub-unit 302c is configured to determine that the unmanned aerial vehicle is in the handheld flat-laying state in a case that the amount of position change of the unmanned aerial vehicle is less than a preset position change amount threshold and the amount of attitude change of the unmanned aerial vehicle is less than a preset attitude change amount threshold.

When the unmanned aerial vehicle is in the handheld flat-laying state for the predetermined time period, a current position of the unmanned aerial vehicle may be determined to be an initial position. It should be noted that, the velocity and the angular velocity of the unmanned aerial vehicle are zero when the unmanned aerial vehicle is in the handheld flat-laying state. When the unmanned aerial vehicle is released from the hand, the self-adaptation process of the unmanned aerial vehicle needs to be performed thus the unmanned aerial vehicle may hover stably in the air. At the time instant at which the unmanned aerial vehicle is released from the hand, the unmanned aerial vehicle needs to adjust its attitude to be in the initial position. Therefore, various sensors provided on the unmanned aerial vehicle detect a state of the unmanned aerial vehicle, compare a current state with a state at the initial position, and control parameters such as the velocity, the angular velocity and an acceleration of the unmanned aerial vehicle according to the comparison result, thus the unmanned aerial vehicle is able to stably hover in the air after the unmanned aerial vehicle is released from the hand, i.e., the unmanned aerial vehicle may maintain a same state as at the initial position.

Based on the above method and device for flying an unmanned aerial vehicle in a handheld manner, an unmanned aerial vehicle capable of being flown in a handheld manner is further provided according to the embodiments of the disclosure, and the operation principle thereof will be described in more detail in conjunction with the drawings in the following.

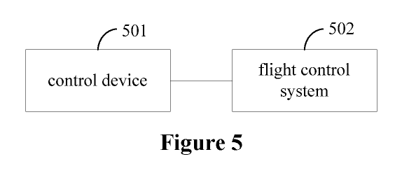

Reference is made to FIG. 5, which is a schematic diagram of an unmanned aerial vehicle capable of being flown in a handheld manner according to the disclosure.

The unmanned aerial vehicle capable of being flown in a handheld manner according to the disclosure includes a control device 501 and a flight control system 502.

The control device 501 is configured to judge whether the unmanned aerial vehicle is triggered to enter a flight standby state, judge whether the unmanned aerial vehicle is in a handheld flat-laying state for a predetermined time period in a case of determining that the unmanned aerial vehicle enters the flight standby state; and compare a state parameter of the unmanned aerial vehicle with the state parameter thereof at a previous time instant to judge whether the unmanned aerial vehicle is released from the hand in a case of determining that the unmanned aerial vehicle is in a handheld flat-laying state, and transmit a control instruction to the flight control system in a case of determining that the unmanned aerial vehicle is released from the hand.

The flight control system 502 is configured to control a rotor wing of the unmanned aerial vehicle to rotate for flight.

The unmanned aerial vehicle according to the embodiment of disclosure is capable of being flown in a handheld manner. The user can fly the unmanned aerial vehicle in a handheld manner without using the remote control device such as the remote control. The unmanned aerial vehicle can perform the self-adaptation process when the user release his/her hand, thus the unmanned aerial vehicle may be flown. The unmanned aerial vehicle is controlled more freely, and the user may fly the unmanned aerial vehicle conveniently without operating the remote control.

What is described above is only preferred embodiments of the present disclosure and is not intended to limit the present disclosure in any way. The preferred embodiments of the present disclosure are disclosed above, which should not be interpreted as limiting the present disclosure. Numerous alternations, modifications and equivalents can be made to the technical solutions of the present disclosure by those skilled in the art in light of the methods and technical contents disclosed herein without departing from the scope of the present disclosure. Therefore, any alternations, modifications and equivalents made to the embodiments above according to the technical essence of the present disclosure without departing from the scope of the present disclosure should fall within the scope of protection of the present disclosure.

1. A method for flying an unmanned aerial vehicle in a handheld manner, comprising:
judging whether the unmanned aerial vehicle is triggered to enter a flight standby state;
determining whether the unmanned aerial vehicle is in a handheld flat-laying state for a predetermined time period in a case of determining that the unmanned aerial vehicle enters the flight standby state; and
comparing a state parameter of the unmanned aerial vehicle with the state parameter thereof at a previous time instant to judge whether the unmanned aerial vehicle is released in a case of determining that the unmanned aerial vehicle is in the handheld flat-laying state, and controlling a rotor wing of the unmanned aerial vehicle to rotate for flight in a case of determining that the unmanned aerial vehicle is released.

2. The method for flying the unmanned aerial vehicle in the handheld manner according to claim 1, wherein the judging whether the unmanned aerial vehicle is triggered to enter the flight standby state comprises:
judging whether a flight standby switch provided on the unmanned aerial vehicle is turned on; or
judging whether a motion trajectory along which the unmanned aerial vehicle is lifted by hand follows a predetermined flight standby trajectory.

3. The method for flying the unmanned aerial vehicle in the handheld manner according to claim 2, wherein the judging whether the motion trajectory along which the unmanned aerial vehicle is lifted by hand follows the predetermined flight standby trajectory, to judge whether the unmanned aerial vehicle is triggered to enter the flight standby state, comprises:
detecting a position parameter (xᵢ, yᵢ, zᵢ) of the unmanned aerial vehicle at a time instant tᵢ, where xᵢ and yᵢ are two-dimensional coordinates on a x-axis and a y-axis in a horizontal plane parallel to the ground respectively, zᵢ is a coordinate on a z-axis perpendicular to the ground, and tᵢ is a timestamp;
judging whether components of the motion trajectory of the unmanned aerial vehicle in the x-axis and the y-axis extend monotonically in a positive direction or a negative direction along the x-axis and the y-axis respectively according to xᵢ and yᵢ, and judging whether a component of the motion trajectory of the unmanned aerial vehicle in the z-axis extends monotonically in a positive direction along the z-axis according to zᵢ;
determining that the unmanned aerial vehicle enters the flight standby state in a case of determining that the components of the motion trajectory of the unmanned aerial vehicle in the x-axis and the y-axis extend monotonically in the positive direction or the negative direction along the x-axis and the y-axis respectively, and the component of the motion trajectory of the unmanned aerial vehicle in the z-axis extends monotonically in the positive direction along the z-axis.

4. The method for flying the unmanned aerial vehicle in the handheld manner according to claim 3, wherein whether the component of the motion trajectory of the unmanned aerial vehicle in the x-axis extends monotonically in the positive direction or the negative direction along the x-axis is judged according to xᵢ with the following equation:
$$\vert \sum \frac{{dx}_{i}}{{dt}_{i}} \vert \geq {T}_{1} \sum \vert \frac{{dx}_{i}}{{dt}_{i}} \vert ;$$
whether the component of the motion trajectory of the unmanned aerial vehicle in the y-axis extends monotonically in the positive direction or the negative direction along the y-axis is judged according to yᵢ with the following equation:
$$\vert \sum \frac{{dy}_{i}}{{dt}_{i}} \vert \geq {T}_{1} \sum \vert \frac{{dy}_{i}}{{dt}_{i}} \vert ;$$
and
whether the component of the motion trajectory of the unmanned aerial vehicle in the z-axis extends monotonically in the positive direction along the z-axis is judged according to zᵢ with the following equation:
$$\sum \frac{{dz}_{i}}{{dt}_{i}} \geq {T}_{2} \sum \vert \frac{{dz}_{i}}{{dt}_{i}} \vert ,$$
where T₁ is a preset value greater than 0 and less than or equal to 1, and T₂ is a preset value greater than 0 and less than or equal to 1.

5. The method for flying the unmanned aerial vehicle in the handheld manner according to claim 1, wherein the determining whether the unmanned aerial vehicle is in a handheld flat-laying state for a predetermined time period comprises:
acquiring an amount of position change of the unmanned aerial vehicle based on the position parameter of the unmanned aerial vehicle;
acquiring an amount of attitude change of the unmanned aerial vehicle based on an attitude parameter of the unmanned aerial vehicle; and
determining that the unmanned aerial vehicle is in the handheld flat-laying state in a case that the amount of position change of the unmanned aerial vehicle is less than a preset position change amount threshold and the amount of attitude change of the unmanned aerial vehicle is less than a preset attitude change amount threshold.

6. The method for flying the unmanned aerial vehicle in the handheld manner according to claim 5, wherein the amount of position change of the unmanned aerial vehicle Vₜ_{ᵢ}^{P} is acquired based on the position parameter of the unmanned aerial vehicle with the following equation:
Vₜ_{ᵢ}^{P}=|dxᵢ|+|dyᵢ|+|dzᵢ|,
where (xᵢ, yᵢ, zᵢ) is the position parameter of the unmanned aerial vehicle at a time instant tᵢ, xᵢ and yᵢ are two-dimensional coordinates on the x-axis and the y-axis in a horizontal plane parallel to the ground respectively, zᵢ is a coordinate on the z-axis perpendicular to the ground, and tᵢ is a timestamp; and
the amount of attitude change of the unmanned aerial vehicle Vₜ_{ᵢ}^{O} is acquired based on the attitude parameter of the unmanned aerial vehicle with the following equation:
Vₜ_{ᵢ}^{O}=|dφᵢ|+|dθᵢ|+|dψᵢ|,
where (φᵢ,θᵢ,ψᵢ) is the attitude parameter of the unmanned aerial vehicle at the time instant tᵢ, and
the determining that the unmanned aerial vehicle is in the handheld flat-laying state in a case that the amount of position change of the unmanned aerial vehicle is less than the preset position change amount threshold and the amount of attitude change of the unmanned aerial vehicle is less than the preset attitude change amount threshold comprises:
determining that the unmanned aerial vehicle is in the handheld flat-laying state in a case that a maximum value of the amount of position change is less than the preset position change amount threshold and a maximum value of the amount of attitude change is less than the preset attitude change amount threshold in a predetermined time window (tₐ, t_{b}).

7. A device for flying an unmanned aerial vehicle in a handheld manner, comprising:
a first judgment unit configured to judge whether the unmanned aerial vehicle is triggered to enter a flight standby state;
a second judgment unit configured to judge whether the unmanned aerial vehicle is in a handheld flat-laying state for a predetermined time period in a case of the first judgment unit determining that the unmanned aerial vehicle enters the flight standby state; and
a comparison unit configured to compare a state parameter of the unmanned aerial vehicle with the state parameter thereof at a previous time instant in a case of the second judgment unit determining that the unmanned aerial vehicle is in the handheld flat-laying state; and
a control unit configured to control a rotor wing of the unmanned aerial vehicle to rotate for flight in a case of the comparison unit determining that the unmanned aerial vehicle is released according to a comparison result.

8. The device for flying the unmanned aerial vehicle in the handheld manner according to claim 7, wherein, in a case that the first judgment unit is configured to determine that the unmanned aerial vehicle is triggered to enter the flight standby state by judging whether a motion trajectory along which the unmanned aerial vehicle is lifted by hand follows a predetermined flight standby trajectory, the first judgment unit comprises:
a position parameter detection sub-unit configured to detect a position parameter (xᵢ, yᵢ, zᵢ) of the unmanned aerial vehicle at a time instant tᵢ, where xᵢ and yᵢ are two-dimensional coordinates on a x-axis and a y-axis in a horizontal plane parallel to the ground respectively, zᵢ is a coordinate on a z-axis perpendicular to the ground, and tᵢ is a timestamp;
a first judgment sub-unit configured to judge whether components of the motion trajectory of the unmanned aerial vehicle in the x-axis and the y-axis extend monotonically in a positive direction or a negative direction along the x-axis and the y-axis respectively according to xᵢ and yᵢ, and judge whether a component of the motion trajectory of the unmanned aerial vehicle in the z-axis extends monotonically in a positive direction along the z-axis according to zᵢ;
a first determination sub-unit configured to determine that the unmanned aerial vehicle enters the flight standby state, in a case of the first judgment sub-unit determining that components of the motion trajectory of the unmanned aerial vehicle in the x-axis and the y-axis extend monotonically in the positive direction or the negative direction along the x-axis and the y-axis respectively, and a component of the motion trajectory of the unmanned aerial vehicle in the z-axis extends monotonically in the positive direction along the z-axis.

9. The device for flying the unmanned aerial vehicle in the handheld manner according to claim 7, wherein the second judgment unit comprises:
a position change amount acquisition sub-unit configured to acquire an amount of position change of the unmanned aerial vehicle based on the position parameter of the unmanned aerial vehicle;
an attitude change amount acquisition sub-unit configured to acquire an amount of attitude change of the unmanned aerial vehicle based on an attitude parameter of the unmanned aerial vehicle; and
a second judgment sub-unit configured to determine that the unmanned aerial vehicle is in the handheld flat-laying state in a case that the amount of position change of the unmanned aerial vehicle is less than a preset position change amount threshold and the amount of attitude change of the unmanned aerial vehicle is less than a preset attitude change amount threshold.

10. An unmanned aerial vehicle capable of being flown in a handheld manner, comprising:
a control device configured to judge whether the unmanned aerial vehicle is triggered to enter a flight standby state, determine whether the unmanned aerial vehicle is in a handheld flat-laying state for a predetermined time period in a case of determining that the unmanned aerial vehicle enters the flight standby state; and compare a state parameter of the unmanned aerial vehicle with the state parameter thereof at a previous time instant to judge whether the unmanned aerial vehicle is released in a case of determining that the unmanned aerial vehicle is in the handheld flat-laying state, and transmit a control instruction to a flight control system in a case of determining that the unmanned aerial vehicle is released; and
the flight control system configured to control a rotor wing of the unmanned aerial vehicle to rotate for flight.
